(19) United States
(12) Patent Application Publication
(10) Pub. No.: US 2012/0110259 A1
(43) Pub. Date: May 3, 2012

(54) TIERED DATA STORAGE SYSTEM WITH DATA MANAGEMENT AND METHOD OF OPERATION THEREOF

(75) Inventors: Andrew Mills, Coto de Caza, CA (US); Marshall Lee, Newport Coast, CA (US)

(73) Assignee: ENMOTUS INC., Aliso Viejo, CA (US)

(21) Appl. No.: 13/282,411

(22) Filed: Oct. 26, 2011

Related U.S. Application Data
(60) Provisional application No. 61/407,432, filed on Oct. 27, 2010.

(51) Int. Cl. G06F 12/08; G06F 12/06

(52) U.S. Cl. 711/113; 711/209; 711/E12.017; 711/E12.078

(57) ABSTRACT

A method of operation of a data storage system includes: enabling a system interface for receiving host commands; updating a mapping register for monitoring transaction records of a logical block address for the host commands including translating a host virtual block address to a physical address for storage devices; accessing by a storage processor, the mapping register for comparing the transaction records with a tiering policies register; and enabling a tiered storage engine for transferring host data blocks by the system interface and concurrently transferring between a tier zero, a tier one, or a tier two if the storage processor determines the transaction records exceed the tiering policies register.

### CROSS-REFERENCE TO RELATED APPLICATION

This application claims the benefit of U.S. Provisional Patent Application Ser. No. 61/407,432 filed Oct. 27, 2010, and the subject matter thereof is incorporated herein by reference thereto.

### TECHNICAL FIELD

The present invention relates generally to a data storage system, and more particularly to a system for managing data storage on servers and networks.

### BACKGROUND ART

With the exponential rise of unstructured data being created in today's modern data center, networked computer, and corporate information systems, it has become increasingly difficult to manage and ensure that frequently accessed and important data resides on the highest performance storage, often referred to as “primary storage”, and that older data resides on less costly and lower performance archive oriented storage. Examples of primary storage include “Solid State Disks” (“SSD”) or the highest performance magnetic disk drives, such as 15,000 RPM based “Serial Attached SCSI” (“SAS”) disk drives.

Examples of archive storage include “secondary storage” utilizing low cost disk drive technology e.g. “Serial Advanced Technology Attachment” (“SATA”) disk arrays or “Massive Arrays of Idle Disks” (“MAID”), or archives based on older tape media. Each type of storage has different attributes related to access times and latency, raw performance and cost. For example, at today's prices, high end SSDs can cost over 1000 times that of tape media on a per gigabyte capacity basis, and over 50 times the cost of SAS disk drives.

Due to these differences in cost, performance and energy, many computer systems are relying more on a virtualized storage environment that can virtualize a mix of the different storage media types as one large (or segmented) virtual data volume to the host computer's file system, as well as automatically assign data to the most appropriate storage type or tier without the involvement of the host computer application or the computer file system.

Thus, a need still remains for a data storage system with data management. In view of the ever increasing demand for data storage that spans the performance and cost spectrum, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a data storage system including: enabling a system interface for receiving host commands; updating a mapping register for monitoring transaction records of a logical block address for the host commands including translating a host virtual block address to a physical address for storage devices; accessing by a storage processor, the mapping register for comparing the transaction records with a tiering policies register; and enabling a tiered storage engine for transferring host data blocks by the system interface and concurrently transferring between a tier zero, a tier one, or a tier two if the storage processor determines the transaction records exceed the tiering policies register.

The present invention provides a data storage system including: a system interface for receiving host commands; a mapping register addressed by the system interface for monitoring transaction records of a logical block address for the host commands includes a host virtual block address translated to a physical address of storage devices; a storage processor coupled to the mapping register for comparing the transaction records with a tiering policies register; and a tiered storage engine coupled to the storage processor for transferring host data blocks by the system interface and concurrently transferring between a tier zero, a tier one, or a tier two if the storage processor determines the transaction records exceed the tiering policies register.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a functional block diagram of a tiered data storage system in an embodiment of the present invention.

FIG. 2 is a functional block diagram of a system application of the tiered data storage system.

FIG. 3 is a functional block diagram of a system application of a tiered data storage system in a second embodiment of the present invention.

FIG. 4 is a functional block diagram a tiered storage array managed by the tiered data storage system.

FIG. 5 is a flow diagram of a host read command executed by the tiered data storage system.

FIG. 6 is a flow diagram of a host write command executed by the tiered data storage system.

FIG. 7 is a computer system having a virtualized view of the tiered data storage system.

FIG. 8 is an architectural block diagram of the tiered data storage system.

FIG. 9 is a block diagram of a system application of the tiered data storage system.

FIG. 10 is a flow diagram of a background scan of the tiered data storage system.

FIG. 11 is a functional block diagram of the tiered data storage system in a snapshot operation.

FIG. 12 is a flow chart of a method of operation of the tiered data storage system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals.

For expository purposes, the term “horizontal” as used herein is defined as a plane parallel to the plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

The term “processing” as used herein transferring and storing system data and programs. The term “tiered storage” is defined to be a structure in which data can be stored on a device having performance that is commensurate with the frequency of data usage. By way of an example, data that is infrequently used, such as census data, can be stored on low performance and inexpensive archival storage devices, while frequently accessed program data can be stored on solid state disks or magnetic hard disk drives that rotate at 15,000 RPM and communicate through high performance interfaces that are more expensive. The term “archival device” is defined as a low performance storage device having very high capacity, such as a magnetic tape storage device, or optical media storage device, for example.

The term “tier zero” is defined to be a grouping of the highest performance storage devices, which can include cache memory structures, solid state disks, and the highest performance magnetic hard disk drives, having high performance interfaces. The term “tier one” is defined to be a grouping of intermediate performance storage devices that provide high capacities, which can include magnetic hard disk drives having moderate performance interfaces. The term “tier two” is defined to be a grouping of the lowest performance storage devices, which can include archival devices such as magnetic tape storage devices or optical media storage devices having the lowest performance interfaces. It is understood that while the description of the present invention uses three tiers in order to explain its operation, any number of tiers can be defined in other implementations. Multiple tiers are typical in many applications, however a different number of tiers of storage may also be present beyond these three types to address other performance or data protection criteria, or other storage media types such as storage class memory (SCM), or other emerging memory technologies (i.e. phase change, spin-programmable, memristor and other similar technologies).

The term “in-band” is defined to be a messaging methodology that utilizes the primary interface to convey system management information, thereby consuming some of the bandwidth of the primary interface. The term “out-of-band” is defined to be a messaging methodology that uses means other than the primary interface to convey system management information, thereby consuming none of the bandwidth of the primary interface.

In regards to tiered storage, the term “promote” is defined to mean the transfer of target data from one performance tier to a higher performance tier by physically moving the target data to a higher performance storage device which is associated with the higher performance tier. In regards to tiered storage, the term “demote” is defined to mean the transfer of target data from one performance tier to a lower performance tier by physically moving the target data to a lower performance storage device which is associated with the lower performance tier.

The term “commensurate” as used in this application is defined to be an appropriate performance level for the frequency of data use, thereby providing high performance storage devices for frequently used data and low performance storage devices for infrequently used data. The term “autonomous” as used in this application is defined to mean the tiered data storage system does not require the assistance or permission of any external host resource to promote or demote the target data.

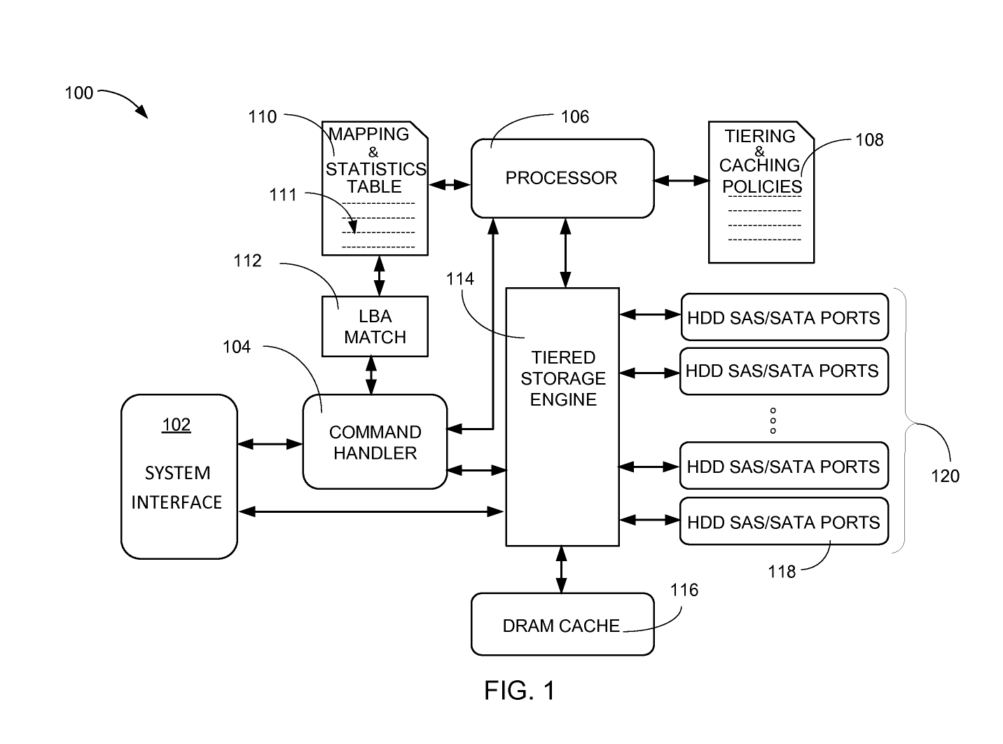

Referring now to FIG. 1, therein is shown a functional block diagram of a tiered data storage system 100 in an embodiment of the present invention. The functional block diagram of the tiered data storage system 100 depicts a system interface 102, such as a personal computer interface express (PCI-e)™, universal serial bus (USB)™, Thunderbolt™, for example. The system interface 102 can be coupled to a command handler 104.

The command handler 104 is defined to be a hardware accelerator for decoding and executing commands received through the system interface 102. The command handler 104 can be a mix of combinational logic, program sequencer, sequential state machine, for example. The command handler 104 manages the receipt of commands, from the system interface 102, decodes the commands, manages the execution of the commands, and performs error management and recovery for any transaction with the system interface 102.

The command handler 104 can be coupled to a storage processor 106, such as a microprocessor, or an embedded microcomputer. The storage processor 106 controls the overall operation of the tiered data storage system 100 without being involved with every data transfer request from the host interface 102. The storage processor 106 can be interrupt driven, operate by polling, or a combination thereof. The storage processor can be guided by a tiering policies register 108. The tiering policies register 108 can be a register array or non-volatile memory which contains rules associated with the storage of data transferred through the system interface 102. The rules of the tiering policies register 108 can be pre-negotiated with the host central processing unit (not shown).

The storage processor 106 can provide an in-band or out-of-band management interface (not shown) to the host central processing unit (not shown) to modify the policies or other parameters of the tiering policies register 108. This interface may use for example methods such as vendor specific “SMART” commands via an advanced host computer interface (AHCI) or other means to communicate with the storage processor 106.

A mapping register 110 can be a register array or non-volatile memory which is accessed by the storage processor 106 in order to manage the storage location and accesses of the data transferred through the system interface 102. The mapping register 110 can keep transaction records 111, such as virtual to physical block mapping and statistics of the number and frequency of accesses to blocks of the data transferred through the system interface 102.

The interaction between the storage processor 106 and the mapping register 110 can constantly monitor whether the data transferred through the system interface 102 should be promoted or demoted based on the tiering policies register 108. Based on the rules of the tiering policies register 108, the storage processor 106 can determine that the data transferred through the system interface 102 should be relocated to storage device (not shown) that has performance commensurate with the number and type of accesses entered in the mapping register 110.

In making the promote or demote decision the storage processor 106 can consider the transaction records 111 of read and write on the allocation blocks including priority, the level of the logical drive that is allocated to tiering, any locking parameters, and the wear level of any of the solid state drives (SSD's) used.

A logical block address match block 112 is coupled between the command handler 104 and the mapping register 110. The logical block address match block 112 can translate host virtual block requests into physical device or other virtual device requests and quickly identify whether a block of the data, received through the system interface 102, is referenced in the mapping register 110. The logical block address match block 112 can update the mapping register 110 without intervention by the storage processor 106.

The mapping register 110 takes in the host virtual logic block address from the logical block address match block 112 and looks up which physical disk the host virtual logic block address is mapped to and then determines which page and offset within a particular physical disk. The physical disk can alternatively be a virtual disk such as a RAID 1 set of two physical disks. The logical block address match block 112 converts from the host virtual logic block address to the physical disk page and offset by using a look up function.

The command handler 104 can be coupled to a tiered storage engine 114. The tiered storage engine 114 can receive input directly from the command handler 104 for storing or accessing a block of the data transferred through the system interface 102. The tiered storage engine 114 can optionally hold the data transferred through the system interface 102 in a local cache 116, such as a dynamic random access memory (DRAM) cache. The local cache 116 is an optional addition to the tiered data storage system 100, and if it is not utilized the tiered storage engine 114 can transfer the data directly to a storage device (not shown) such as a Serial Advanced Technology Attachment (SATA) disk drive (not shown). If the local cache 116 is utilized, the tiered storage engine 114 can maintain the data in the local cache 116 in order to determine the appropriate performance level device for the data or transfer the data transferred through the system interface 102 directly to the storage device.

The tiered storage engine 114 can access the SATA disk drive, the SAS disk drive, or a PCI-e attached disk drive through a storage port 118. The storage port 118 can include the support hardware, such as buffers, command generators, and interface sequencers in order to transfer the data from either the local cache 116 or the system interface 102 to the SATA disk drive for storage. As the data is accessed through the system interface 102, the command handler 104 communicates the operation to the logical block address match block 112 in order to update the transaction records 111, for the block of the data, in the mapping register 110.

When the mapping register 110 has collected the transaction records 111, about the use of the block of data that exceeds the limits stored in the tiering policies register 108 the storage processor 106 can initiate a move of the block of data to a different performance device (not shown) that can be accessed through a bank of storage ports 120. The movement of the block of data, initiated by the storage processor 106, can store the block of data in and appropriate tier of storage elements (not shown). The tier of the storage elements can be segregated by performance of the storage elements.

It has been discovered that the tiered data storage system 100 can maintain the optimum system performance by storing the block of data in a storage element that provides the performance commensurate with the use pattern of the block of data. The use of the block of data can be monitored by the logical block address match block 112 and the mapping register 110. The storage processor 106 can promote or demote the data on a particular tier based on an increase or decrease in the use of the block of data. The storage processor 106 can promote or demote the block of data immediately after the execution of a host requested transfer of data through the system interface 102.

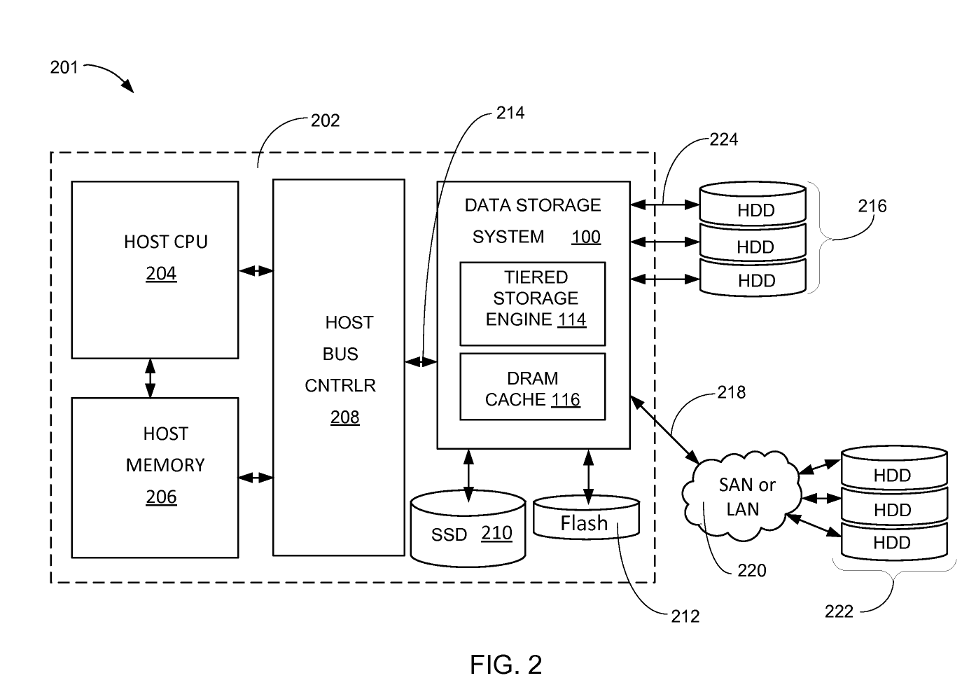

Referring now to FIG. 2, therein is shown a functional block diagram of a system application 201 of the tiered data storage system 100 of FIG. 1. The functional block diagram of the system application 201 depicts the tiered data storage system 100, installed in a host computer 202, such as a server or workstation consisting at least a host central processing unit 204, host memory 206 coupled to the host central processing unit 204, and a host bus controller 208. The host bus controller 208 provides a host interface bus 214, which allows the host computer 202 to utilize the tiered data storage system 100. It is understood that the function of the host bus controller 208 can be provided by host central processing unit 204 in some implementations.

The tiered data storage system 100 includes the tiered storage engine 114 and the local cache 116, if it is optionally included. The tiered data storage system 100 can be coupled to a solid state disk 210, such as a non-volatile memory based storage device having a peripheral interface system, or a non-volatile memory 212, such as an internal memory card for expanded or extended non-volatile system memory.

The tiered data storage system 100 can also be coupled to hard disk drives (HDD) 216 that can be mounted in the host computer 202, external to the host computer 202, or a combination thereof. The solid state disk 210, the non-volatile memory 212, and the hard disk drives 216 are all considered to be direct attached storage (DAS) devices.

The tiered data storage system 100 can also support a network attach port 218 for coupling a local area network (LAN) 220, which can alternatively be a storage area network (SAN). The network attach port 218 can provide access to network attached storage (NAS) devices 222. While the network attached storage devices 222 are shown as hard disk drives, this is an example only. It is understood that the network attached storage devices 222 could include magnetic tape storage (not shown), and storage devices similar to the solid state disk 210, the non-volatile memory 212, or the hard disk drives 216 that are accessed through the network attach port 218.

The tiered data storage system 100 can be attached to the host interface bus 214 for providing access to and interfacing to multiple of the direct attached storage (DAS) devices via a cable 224 through the bank of storage ports 120, of FIG. 1, such as the Serial Advanced Technology Attachment (SATA), the Serial Attached SCSI (SAS), or the Personal Computer Interface-Express (PCI-e) attached storage devices. The tiered storage engine 114 and the local cache 116 enable the tiered data storage system 100 to meet the performance requirements of data provided by the host computer 202 and store that data in the solid state disk 210, the flash memory 212, or the hard disk drives 216 having the commensurate performance.

It has been discovered that the tiered data storage system 100 can manage the data provided by the host computer 202 in order to control the utilization of highest performance storage devices for the most frequently used data by moving designated data to a storage device having less performance. It is understood that storage devices having less than the highest performance with higher volume capacity are less expensive per megabyte. By storing the data in a storage device having performance commensurate with the use pattern of the data, the available capacity of the highest performance storage devices can be efficiently utilized.

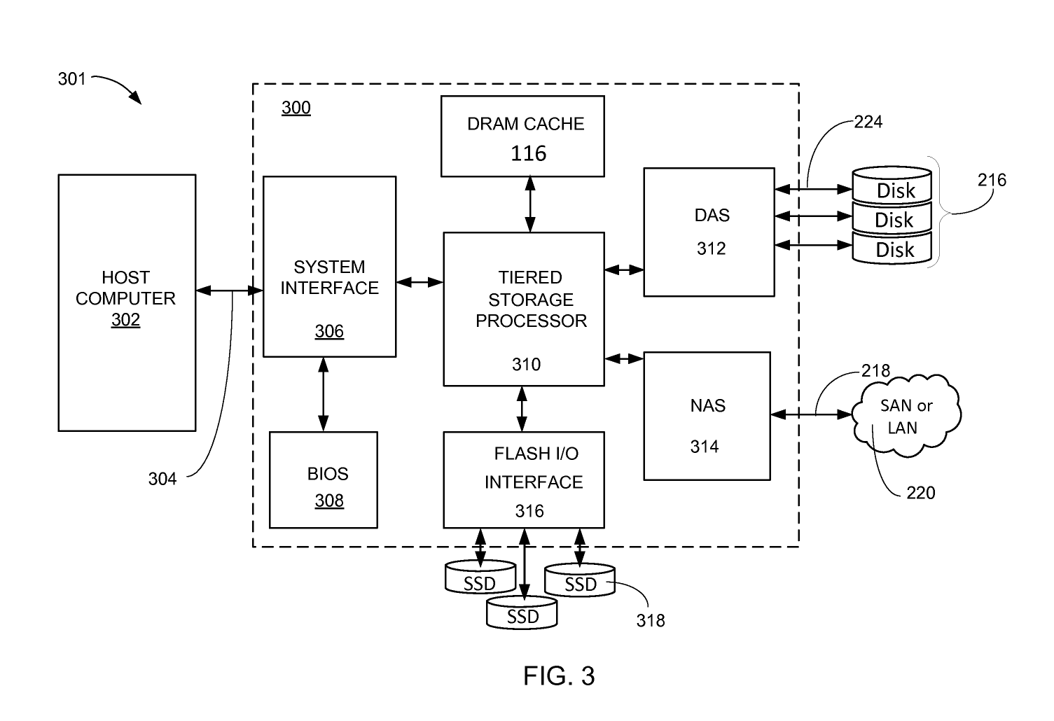

Referring now to FIG. 3, therein is shown a functional block diagram of a system application 301 of a tiered data storage system 300 in a second embodiment of the present invention. The functional block diagram of the system application 301 of the tiered data storage system 300 depicts a host computer 302 having an interface cable 304 coupled to a system interface 306 of the tiered data storage system 300. It is understood that the tiered data storage system 300 can be a stand-alone system having a separate enclosure and power supply, or it may be integrated within the same enclosure as the host computer 302, such as a blade server enclosure.

The interface cable 304 can provide a communication path between the host computer 302 and the tiered data storage system 300 through the system interface 306. The system interface 306 can include an advanced host computer interface (AHCI), a non-volatile memory host computer interface (NVMHCI), an extended non-volatile memory host computer interface (NVMe), a Small Computer System Interface (SCSI) over PCI-e (SOP), or an interface utilizing protocols such as SCSI.

A basic input output system (BIOS) 308, such as read only memory or Flash memory device can be optionally attached. The attachment of the BIOS 308 provides a system bootable environment for the tiered data storage system 300 or it can provide the bootable program to the host computer 302.

The system interface 306 can be coupled to a tiered storage processor 310 for performing tiered storage functions, of collecting the transaction records 111, of FIG. 1, of a block of data, storing the block of data at a temporary performance tier, and promoting or demoting the block of data to a different performance tier based on the transaction records 111 or performing other functions such as block level volume snapshot functions. The tiered storage processor 310 can be implemented as dedicated hardware logic gates and state logic, a micro-coded hardware engine, or a general purpose central processing unit with interface logic that may be dedicated or reprogrammable by a host computer system to perform different types of storage processing or tiering functions.

The tiered storage processor 310 can be coupled to the local cache 116, which optionally provides the local cache for the tiered storage processor 310. The local cache 116 can include an optional power loss protection circuitry (not shown) such as a battery backup or a non-volatile solid state memory equivalent.

The tiered storage processor 310 can be coupled to a direct attach storage (DAS) interface 312 of accessing the hard disk drives 216 through the cable 224. It is understood that the hard disk drives 216 are shown for example only and the direct attach storage interface 312 can be coupled to the Serial Advanced Technology Attachment (SATA) disk drives, the Serial Attached SCSI (SAS) disk drives, or the PCI-e small form-factor storage devices.

The tiered storage processor 310 can be coupled to a network attach storage (NAS) interface which can provide a connection through the network attach port 218 for coupling the local area network (LAN) 220, which can alternatively be a storage area network (SAN). The network attach port 218 can provide access to the network attached storage (NAS) devices 222, of FIG. 2. It is understood that the network attached storage devices 222 could include magnetic tape storage (not shown), the solid state disk 210, the flash memory 212, or the hard disk drives 216 that are accessed through the network attach port 218.

The tiered storage processor 310 can be coupled to a network adapter 314. The network adapter 314 can be coupled through the network attach port 218 for coupling the local area network (LAN) 220, which can alternatively be the storage area network (SAN). It is understood that the local area network 220 can provide access to additional storage devices (not shown) that can be utilized by the tiered data storage system 300.

The tiered storage processor 310 can be coupled to a flash interface 316 which provides access to SATA storage devices, SAS storage devices, or PCI-e attached storage devices that can be solid state drives 318. The solid state drives 318 are connected via the cable 224 or can be directly embedded onto the tiered data storage system 300 using modules (not shown) or direct mount the solid state drives 318 components (not shown) in order to provide a local high performance storage tier or hybrid tier plus data cache for other storage tiers. It is understood that the storage devices coupled to the flash interface 316 can be the solid state drives 318 or any other non-volatile memory based storage device (not shown).

It has been discovered that the tiered data storage system 300 can operate as a stand-alone peripheral device to manage the data provided by the host computer 202 in order to control the utilization of highest performance storage devices for the most frequently used data by moving designated data to a storage device having less performance. It is understood that storage devices having less than the highest performance with higher volume capacity are less expensive per megabyte. By storing the data in a storage device having performance commensurate with the frequency of use of the data, the available capacity of the highest performance storage devices can be efficiently utilized.

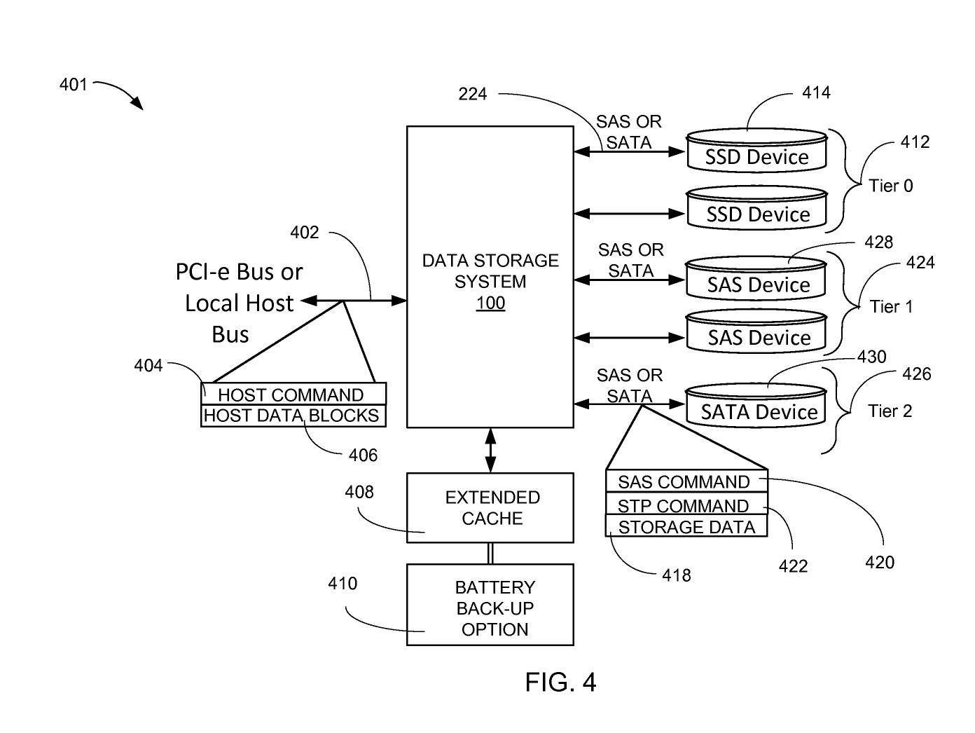

Referring now to FIG. 4, therein is shown a functional block diagram of a tiered storage array 401 managed by the tiered data storage system 100. The functional block diagram of the tiered storage array 401 depicts the tiered data storage system 100 having an interface connection 402 to a personal computer interface bus (PCI-e) or a host local bus.

The interface connection 402 can convey host commands 404, such as advanced host computer interface (AHCI) commands, SOP commands, NVMe commands, and host data blocks 406 to the tiered data storage system 100. An extended cache 408, such as a random access memory, can be coupled to the tiered data storage system 100. In order to protect any of the host data blocks 406 that might be held in the extended cache 408, a battery back-up 410 can be attached to supply emergency power to the extended cache 408. The extended cache 408 and the storage processor 106, of FIG. 1, can also optionally be used to manage and store the extended cache 408 in order to record the transaction records 111, of FIG. 1, on the host data blocks 406. A battery back-up 410 is optionally provided to maintain the integrity of the extended cache 408 in case of a power failure during operation.

The tiered data storage system 100 is coupled to a tier zero 412 of highest performance storage devices 414, such as solid state disks, by the cable 224 or a backplane connection (not shown). The highest performance storage devices 414 provide the ability to maintain the file system structure that is common to all storage systems without incurring a mechanical delay for positioning a read head over the stored data.

The tiered data storage system 100 can retrieve the host data blocks 406 from the extended cache 408 or directly from the host memory 206, of FIG. 2, through the interface connection 402 and transfer storage data 418 to the tier zero 412. The transfer of the storage data 418 can include communicating by a serial attached SCSI (SAS) command 420, the SAS based SATA Tunneling protocol (STP) 422, or by other storage interface commands from interfaces such as SATA, NVMe, PCI-e, or SOP. The tiered data storage system 100 can determine that the transaction records 111 of the storage data 418 indicates that the performance requirements do not justify consuming space on the tier zero 412 and can move the data, under control of the storage processor 106, of FIG. 1, to either tier one 424 or tier two 426.

It is understood that number and definition of the tiers of the tiered data storage system 100 can be different. Any number of the tiers can be implemented in an order of the highest performance storage devices 414 through the slowest storage devices (not shown). As new versions of the highest performance storage devices 414 are introduced, they can displace the existing versions of the highest performance storage devices 414 into a lower performance tier.

The tier one 424 can include intermediate speed storage devices 428, such as serial attached SCSI (SAS) magnetic disks or serial advanced technology attachment (SATA) magnetic disks. While the performance of the intermediate speed storage devices 428 is less than the highest performance storage devices 414 they provide significantly more capacity at a reduced cost per mega-byte. The intermediate speed storage devices 428 can have slower response time than the highest performance storage devices 414 because they have to mechanically position the head over concentric data tracks in order to access the storage data 418.

The tier two 426 can include archival devices 430, such as lower performance disk drives, tape drives, or optical storage drives. The archival devices 430 can provide the lowest performance due to the time required to position or interact with the media. These devices typically have a very low cost per mega-byte for storage capacity but can provide very high capacities when compared to the highest performance storage devices 414 and the intermediate speed storage devices 428.

While only two of the highest performance storage devices 414 and the intermediate speed storage devices 428 are shown, it is understood that this is an example and any appropriate number of the highest performance storage devices 414 and the intermediate speed storage devices 428 can be coupled to the tiered data storage system 100.

It has been discovered that the tiered data storage system 100 provides access to the highest performance storage devices 414, the intermediate speed storage devices 428, and the archival devices 430 through the interface connection 402 to the host computer 302, of FIG. 3, without installing a software driver in the host computer 302. This provides the following value above and beyond a proprietary interface: a user can install the tiered data storage system 100 in an existing configuration of the host computer 302 without the need to reconfigure the operating system, and the tiered data storage system 100 also works seamlessly with all standard X86 based servers, workstations and PCs independent of the operating system they utilize, such as VMware ESXi™, OSX™, Solaris X86™, Linux™ as well as Windows™.

It has also been discovered that the tiered data storage system 100 can monitor the transaction records 111 of the storage data 418 in order to determine if the storage data can be moved to the tier zero 412, the tier one 424, or the tier two 426 in order to provide performance of the storage devices commensurate with the use of the storage data 418. The ability of the tiered data storage system 100 to move the storage data between the tier zero 412, the tier one 424, or the tier two 426 optimizes the use of the tier zero 412 capacity and improves the overall system performance.

It is understood that the figures and description address only three tiers, but this is an example only for ease of understanding. Any number of the tiers can be implemented based on media type, connectivity, write endurance, data protection level or performance.

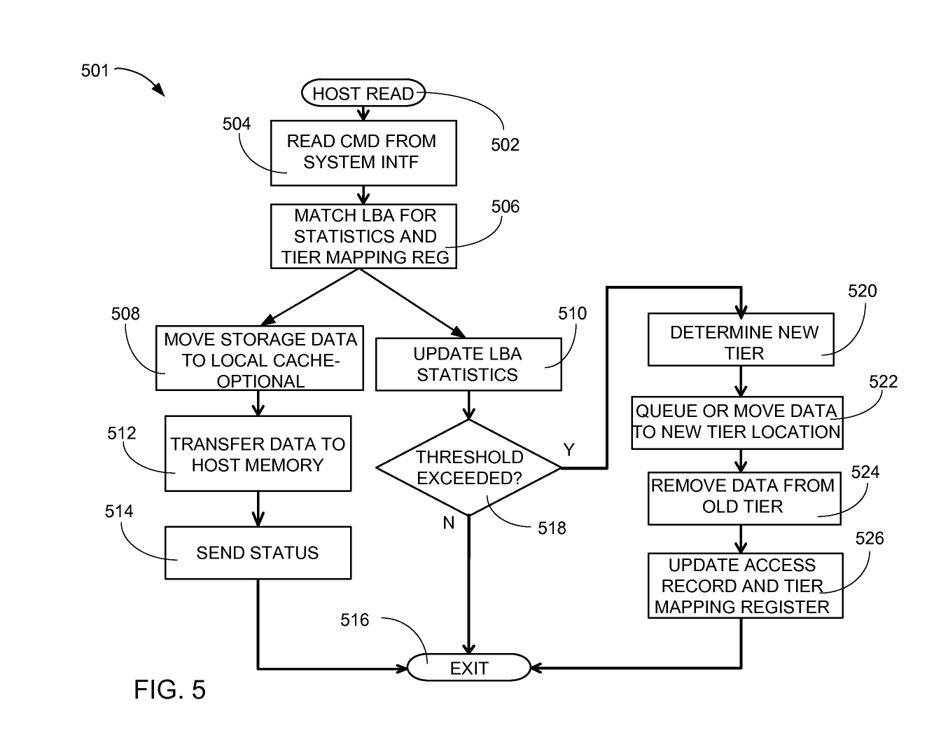

Referring now to FIG. 5, therein is shown a flow diagram of a host read command 501 executed by the tiered data storage system 100, of FIG. 1. The flow diagram of the host read command 501 depicts a host read entry 502 that proceeds to a read command received block 504. The read command received block 504 is initiated by the command handler 104, of FIG. 1.

In a match LBA for transaction records block 506 the command handler 104 can activate the logical block address match block 112, of FIG. 1, in order to access the mapping register 110, of FIG. 1. The flow then proceeds by activating both a move storage data to cache block 508 and an update LBA transaction records block 510. The move storage data to cache block 508 can be optionally skipped, in which case the flow then proceeds to a transfer data to host block 512.

The tiered data storage system 100, of FIG. 1 can divide the processing in order to execute both of the flow chart paths concurrently. The tiered storage engine 114, of FIG. 1, can execute the data transfer to the system interface 102, of FIG. 1, while the storage processor 106, of FIG. 1, can manage the transaction records 111, of FIG. 1, and handle any change of tier that might be required. The description of the flow will discuss the portion executed by the tiered storage engine 114 initially, though it is understood that both flow portions execute concurrently.

The flow executed by the tiered storage engine 114 proceeds to the move storage data to cache block 508 or directly to host memory via system interface 102. In this block of the flow, when the cache is utilized, the tiered storage engine 114 utilizes the information provided by the command handler 104 to access the tier zero 412, of FIG. 4, the tier one 424, of FIG. 4, or the tier two 426, of FIG. 4, and transfer the storage data 418, of FIG. 4, into the local cache 116, of FIG. 1. The flow then proceeds to the transfer data to host block 512.

The tiered storage engine 114 can transfer the data through the local cache 116 to the system interface 102 for transfer to the host computer 302, of FIG. 3. At the completion of the transfer, the flow proceeds to a send status block 514, in which the tiered storage engine 114 can provide ending status to the system interface 102 for transfer of the status to the host computer 302. The flow then proceeds to an exit block 516 to end the execution by the tiered storage engine 114.

In the meantime, the flow executed by the storage processor 106 proceeds to the update LBA transaction records block 510. The logical block address match block 112 can force an update of the virtual to physical mapping and statistics associated with the logical block address from the command handler 104. The storage processor 106 can retrieve the transaction records 111 from the mapping register 110, of FIG. 1, as well as the information from the tiering policies register 108 for the tier zero 412, the tier one 424, or the tier two 426 that holds the storage data 418.

The flow then proceeds to a threshold check block 518. The storage processor can compare the transaction records 111 retrieved from the mapping register 110 to the criteria read from the tiering policies register 108 to determine if the threshold for the associated one of the tier zero 412, the tier one 424, or the tier two 426, in which the storage data 418 is located, has been exceeded. If the threshold has not been exceeded the storage processor 106 will direct the flow to the exit block 516 to end the execution by the storage processor 106.

If the threshold has been exceeded, the flow then proceeds to a determine new tier block 520. The storage processor 106 can determine whether the storage data 418 should be promoted or demoted to the tier zero 412, the tier one 424, or the tier two 426. The flow then proceeds to a move storage data block 522, in which the storage data is read from the old location and written to the appropriate one of the tier zero 412, the tier one 424, or the tier two 426. Alternatively the storage data can be flagged in a support hardware structure for delayed processing of the relocation of the storage data. The storage data 418 is then written to a new location in the appropriate one of the tier zero 412, the tier one 424, or the tier two 426.

The flow executed by the storage processor 106 then proceeds to a remove data from the old tier block 524, in which the storage processor removes the storage data 418 from the original one of the appropriate one of the tier zero 412, the tier one 424, or the tier two 426. The flow then proceeds to an update record block 526, in which the storage processor 106 updates the mapping register 110 entries, for the storage data 418, to indicate the new location in the appropriate one of the appropriate one of the tier zero 412, the tier one 424, or the tier two 426 and reset or adjust the transaction records 111 in the mapping register 110. The flow then proceeds to the exit block 516 to end the execution by the storage processor 106.

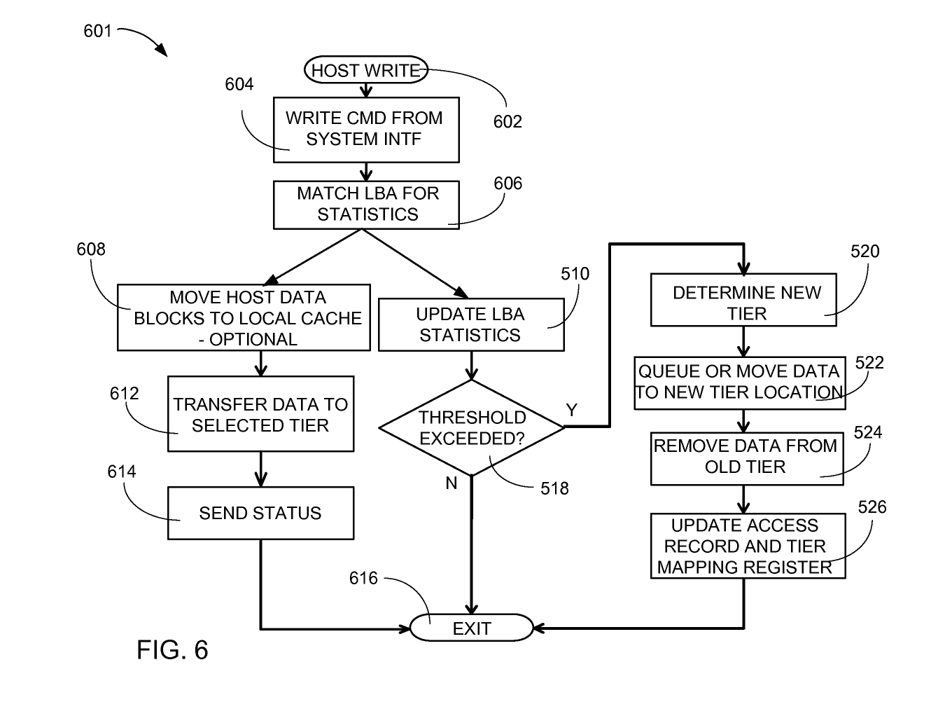

Referring now to FIG. 6, therein is shown a flow diagram of a host write command 601 executed by the tiered data storage system 100, of FIG. 1. The flow diagram of the host write command 601 depicts a host write entry 602 that proceeds to a write command received block 604. The write command received block 604 is initiated by the command handler 104, of FIG. 1.

In a match LBA for transaction records block 606 the command handler 104 can activate the logical block address match block 112, of FIG. 1, in order to access the mapping register 110, of FIG. 1. The flow then proceeds by activating both a move host data to cache block 608 and the update LBA transaction records block 510. Alternatively, where the local cache 116 is not utilized, the flow may bypass step 608 and proceed directly to a transfer data to tier block 612 in order to transfer data directly from the host memory 206, of FIG. 2, via system interface 102, of FIG. 1, when ready to route to the appropriate tier.

The tiered data storage system 100, of FIG. 1 can divide the processing in order to execute both of the flow chart paths concurrently. The tiered storage engine 114, of FIG. 1, can execute the data transfer from the system interface 102, of FIG. 1, while the storage processor 106, of FIG. 1, can manage the transaction records 111, of FIG. 1, and handle any change of tier that might be required. The description of the flow will discuss the portion executed by the tiered storage engine 114 initially, though it is understood that both flow portions execute concurrently.

If the local cache 116, of FIG. 1, is optionally implemented, the flow executed by the tiered storage engine 114 proceeds to the move host data to cache block 608. In this block of the flow, the tiered storage engine 114 utilizes the information provided by the command handler 104 to transfer the host data blocks 406, of FIG. 4, into the local cache 116 in preparation for writing the tier zero 412, of FIG. 4, the tier one 424, of FIG. 4, or the tier two 426, of FIG. 4. The tiered storage engine 114 can access the system interface 102 for transfer from the host computer 302, of FIG. 3. At the completion of the transfer, the flow proceeds to the transfer data to tier block 612.

The tiered storage engine 114 can transfer the data through the local cache 116 to a selected one of the tier zero 412, the tier one 424, or the tier two 426 as the storage data 418, of FIG. 4. At the completion of the data transfer, the flow proceeds to a send status block 614, in which the tiered storage engine 114 can provide ending status to the system interface 102 for transfer of the status to the host computer 302. The flow then proceeds to an exit block 616 to end the execution by the tiered storage engine 114.

In the meantime, the flow executed by the storage processor 106 proceeds to the update LBA transaction records block 510. It is understood that the process performed by the storage processor 106 can be the same for write command 601 as it is for the read command 501, of FIG. 5. The logical block address match block 112 can force an update of the transaction records 111 associated with the logical block address from the command handler 104. The storage processor 106 can retrieve the transaction records 111 from the mapping register 110, of FIG. 1, as well as the information from the tiering policies register 108 for the tier zero 412, the tier one 424, or the tier two 426 that will hold the storage data 418.

The flow then proceeds to the threshold check block 518. The storage processor can compare the transaction records 111 retrieved from the mapping register 110 to the criteria read from the tiering policies register 108 to determine if the threshold for the associated one of the tier zero 412, the tier one 424, or the tier two 426, in which the storage data 418 is located, has been exceeded. If the threshold has not been exceeded the storage processor 106 will direct the flow to the exit block 616 to end the execution by the storage processor 106.

If the threshold has been exceeded, the flow of the storage processor 106 proceeds to the determine new tier block 520. The storage processor 106 can determine whether the storage data 418 should be promoted or demoted to the tier zero 412, the tier one 424, or the tier two 426. The flow then proceeds to the move storage data block 522, in which the storage data is read from the old location to the appropriate one of the tier zero 412, the tier one 424, or the tier two 426. The storage data 418 is then written to a new location in the appropriate one of the tier zero 412, the tier one 424, or the tier two 426.

The flow executed by the storage processor 106 then proceeds to the remove data from the old tier block 524, in which the storage processor removes the storage data 418 from the original appropriate one of the tier zero 412, the tier one 424, or the tier two 426. The flow then proceeds to the update record block 526, in which the storage processor 106 updates the mapping register 110 entries, for the storage data 418, to indicate the new location in the appropriate one of the appropriate one of the tier zero 412, the tier one 424, or the tier two 426 and reset the transaction records 111 in the mapping register 110. The flow then proceeds to the exit block 616 to end the execution by the storage processor 106.

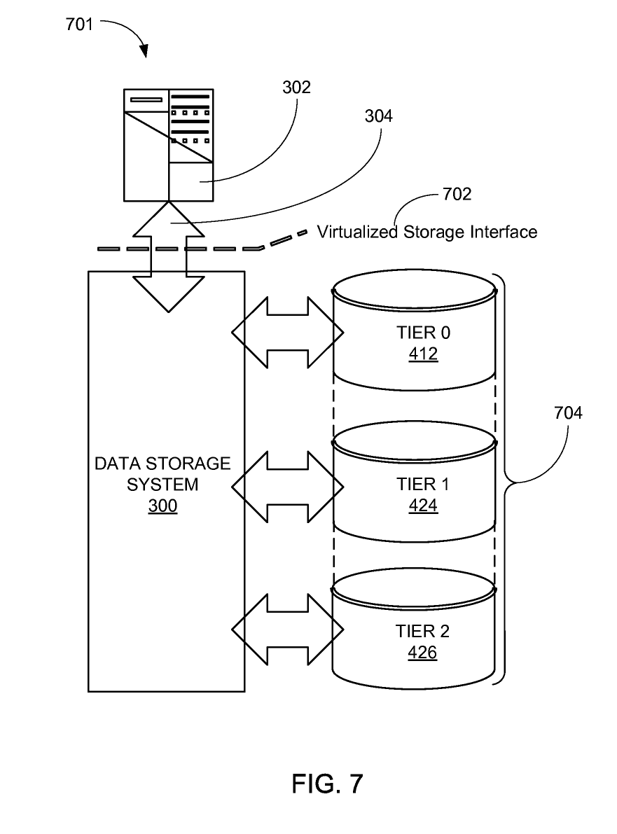

Referring now to FIG. 7, therein is shown a computer system 701 having a virtualized view of the tiered data storage system 300. The computer having the virtualized view of the tiered data storage system 300 depicts the host computer 302 having the interface cable 304 coupled to the tiered data storage system 300. A virtualized storage interface 702 allows the host computer 302 to detect the tiered data storage system 300 as having a single storage element 704.

The tiered data storage system 300 can autonomously manage the tier zero 412, the tier one 424, and the tier two 426 in order to provide the optimized performance commensurate with the use of the data. For data that is frequently read, the tiered data storage system 300 can locate the data in the tier zero 412. And data that written once and seldom read, the tiered data storage system 300 can locate the data in the tier two 426.

The tiered data storage system 300 might initially store the data in the tier one 424 and optionally maintain a copy in the local cache 116, of FIG. 1, in order to develop the transaction records 111, of FIG. 1, for the data. Once a suitable history has been developed, the tiered data storage system 300 can promote or demote the storage data 418, of FIG. 4, to an appropriate one of the tier zero 412, the tier one 424, or the tier two 426 without the knowledge or assistance of the host computer 302.

It has been discovered that the tiered data storage system 300 can either operate as a peripheral device internal to a server, workstation or PC or as a stand-alone external device to manage the data provided by the host computer 302 in order to control the utilization of highest performance storage devices for the most frequently used data by moving designated data to a storage device having less performance. It is understood that storage devices having less than the highest performance with higher volume capacity are less expensive per megabyte. By storing the data in a storage device having performance commensurate with the usage pattern of the data, the available capacity of the highest performance storage devices can be efficiently utilized. Furthermore, by implementing the tiered data storage system 300 using the system interface 102, such as AHCI, SOP or NVMe, the tiered data storage system 300 will work in the majority of operating systems without the need for any changes to the operating system or its drivers. In addition, it is now possible to upgrade existing installed systems non-disruptively and without complex steps to add tiering into a server or virtual server environment.

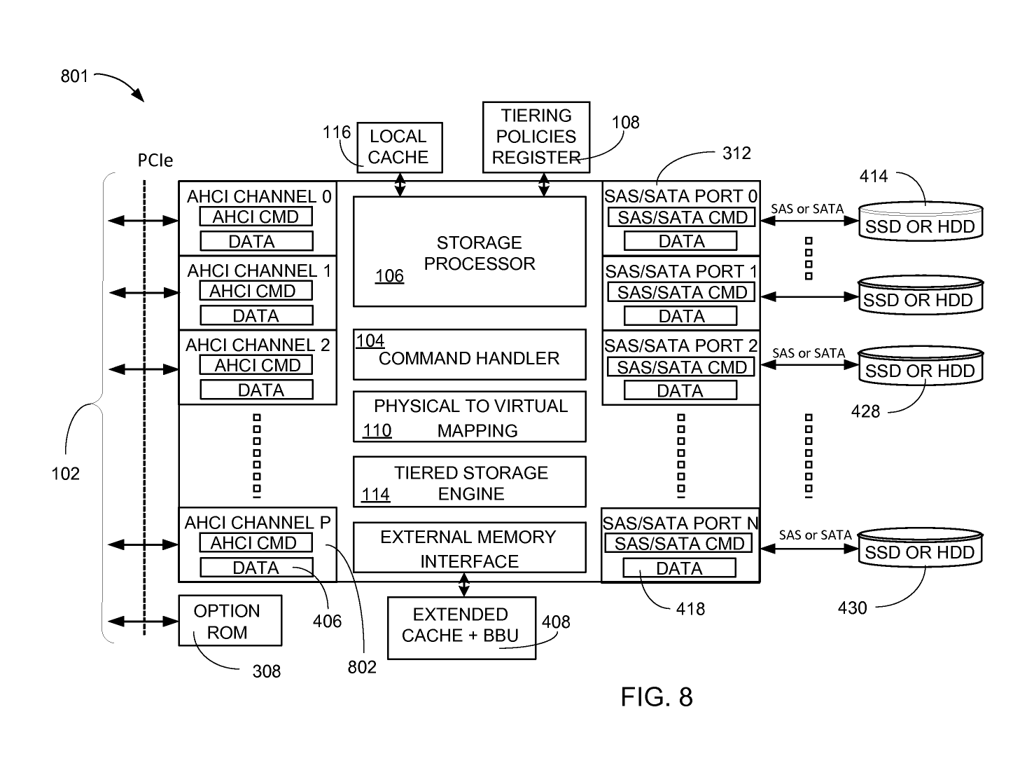

Referring now to FIG. 8, therein is shown an architectural block diagram of the tiered data storage system 100, of FIG. 1. The architectural block diagram of the tiered data storage system 100 depicts the system interface 102 having a channel 802, such as a virtual channel or addressable ports, for receiving the host data blocks 406. The storage processor can interact with the command handler 104, the mapping register 110, the tiered storage engine 114, the local cache 116, the extended cache and battery back-up 408, and the tiering policies register 108. The local cache 116, the extended cache and battery back-up 408 can optionally be omitted.

The direct attach storage interface 312 can contain registers for the storage data 418. The direct attach storage interface 312 can be coupled to the highest performance storage device 414, the intermediate speed storage device 428, or the archival device 430 representing the tier zero 412, of FIG. 4, the tier one 424, of FIG. 4, or the tier two 426, of FIG. 4, respectively.

The direct attach storage interface 312 is shown to have a single storage device per port, but this is an example only and any number of the storage devices can be coupled to the direct attach storage interface 312. The option read only memory 308 is shown coupled to the system interface 102 but this is only an example because it is understood that the option read only memory 308 can be coupled to the storage processor 106 or the tiered storage engine 114.

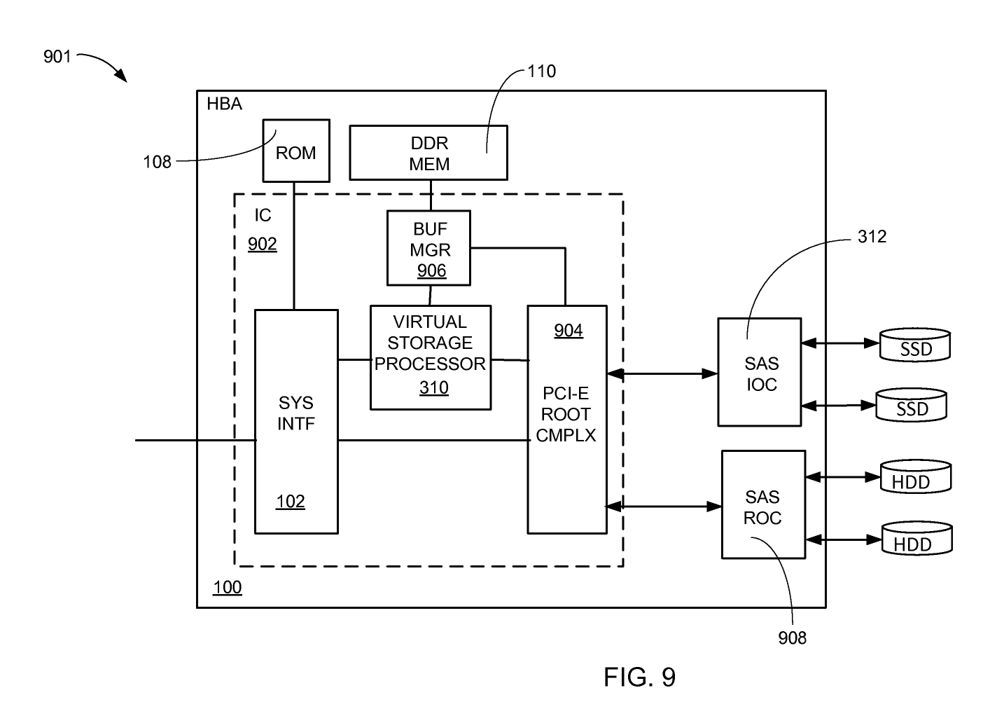

Referring now to FIG. 9, therein is shown a block diagram of a system application 901 of the tiered data storage system 100. The block diagram of the system application 901 depicts the tiered data storage system 100, such as a host bus adapter (HBA) having a tiering integrated circuit 902.

The tiering integrated circuit 902 includes the system interface 102, the tiered storage processor 310, a peripheral controller 904, such as a PCI-express bus controller, and a buffer manager 906. The tiering integrated circuit 902 can be coupled to the direct attach storage interface 312, the mapping register 110, the tiering policies register 108, and an integrated random array of independent disks (RAID) function 908.

It has been discovered that the tiering integrated circuit 902 can provide a highly integrated and compact version of the tiered data storage system 100, while providing the flexibility to change the direct attach storage interface 312 or the integrated RAID function 908 in order to support different disk drive technologies, such as fiber channel or iSCSI.

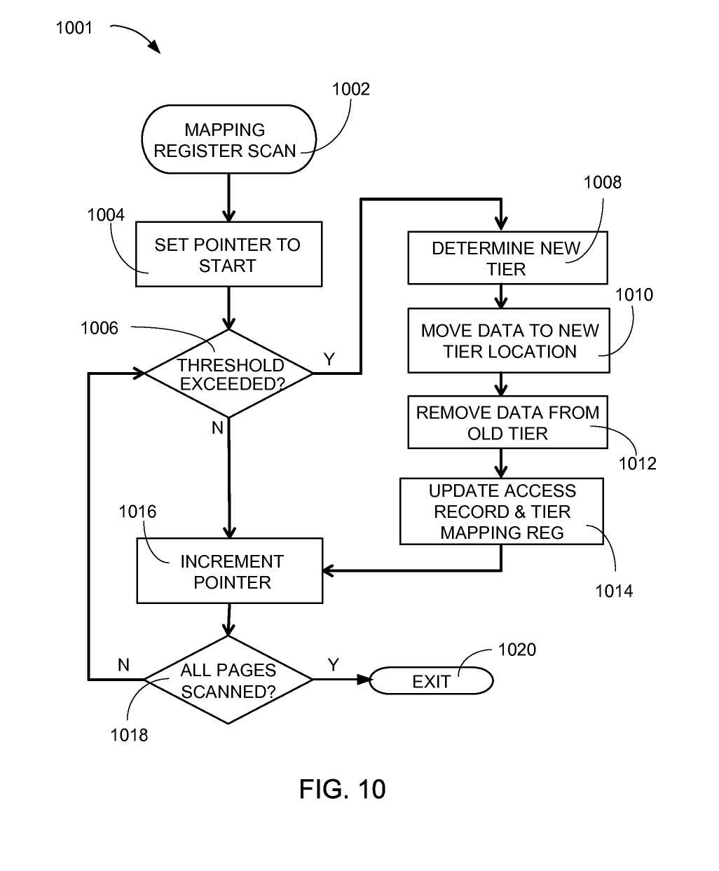

Referring now to FIG. 10, therein is shown a flow diagram of a background scan 1001 of the tiered data storage system 100. The flow diagram of the background scan 1001 depicts a mapping register scan entry 1002, which initiates a background polling process performed by the storage processor 106, of FIG. 1. The flow immediately proceeds to a set pointer to start block 1004.

The storage processor 106 can address the initial page of the mapping register 110, of FIG. 1. The storage processor 106 can read the transaction records 111, of FIG. 1, of the currently addressed page of the mapping register 110. The flow then proceeds to a check thresholds block 1006.

The check thresholds block 1006 requires the storage processor 106 to read the content of the tiering policies register 108 in order to compare the transaction records 111 of the currently addressed page. The check thresholds block 1006 can determine whether the transaction records 111 exceed the limits established by the content of the tiering policies register 108. The content of the tiering policies register 108 can establish whether the logical blocks of data listed on the currently addressed page of the mapping register 110 should remain in the current tier, be promoted to a higher performance tier, or be demoted to a lower performance tier.

If the check thresholds block 1006 determines that the thresholds are exceeded, the flow proceeds to a determine new tier block 1008. In the determine new tier block 1008, the results of the comparison by the storage processor 106 are used to decide which tier the logical blocks of data should be moved to in order to be stored at the tier having the commensurate performance. The flow then proceeds to a move data block 1010.

The move data block 1010 can either add the logical blocks of data to a queue for movement by a hardware support structure (not shown) or physically relocated by the storage processor 106. The move data block 1010 can promote or demote the logical blocks of data as part of the background process without any assistance or knowledge of the host computer 302, of FIG. 3.

The flow does not proceed until the logical blocks of data have been moved to the new tier. When the logical blocks of data are moved to the new tier, the flow proceeds to a remove data block 1012. In which the storage processor 106 can remove the logical blocks of data from the original tier. The storage processor 106 can remove the logical blocks of data by erasing the content of the logical blocks of data or by updating a directory.

The flow then proceeds to an update mapping register block 1014. The storage processor 106 can update the transaction records 111 in the mapping register 110 to indicate that the logical blocks of data have been moved to the new tier.

The flow then proceeds to an increment pointer block 1016, in which the storage processor 106 addresses the subsequent page in the mapping register 110. The increment pointer block 1016 is also the destination of the flow if the check thresholds block 1006 determines that the thresholds of the logical blocks of data have not been exceeded and the logical blocks of data should remain in the current tier. The flow then proceeds to a check all pages scanned block 1018.

If the storage processor 106 determines that the pointer is addressing beyond the last page, the flow proceeds to an exit 1020. If the storage processor 106 determines that the pointer is not addressing beyond the last page, the flow returns to the check thresholds block 1006 in order to continue scanning the transaction records 111, of FIG. 1, at the next page location.

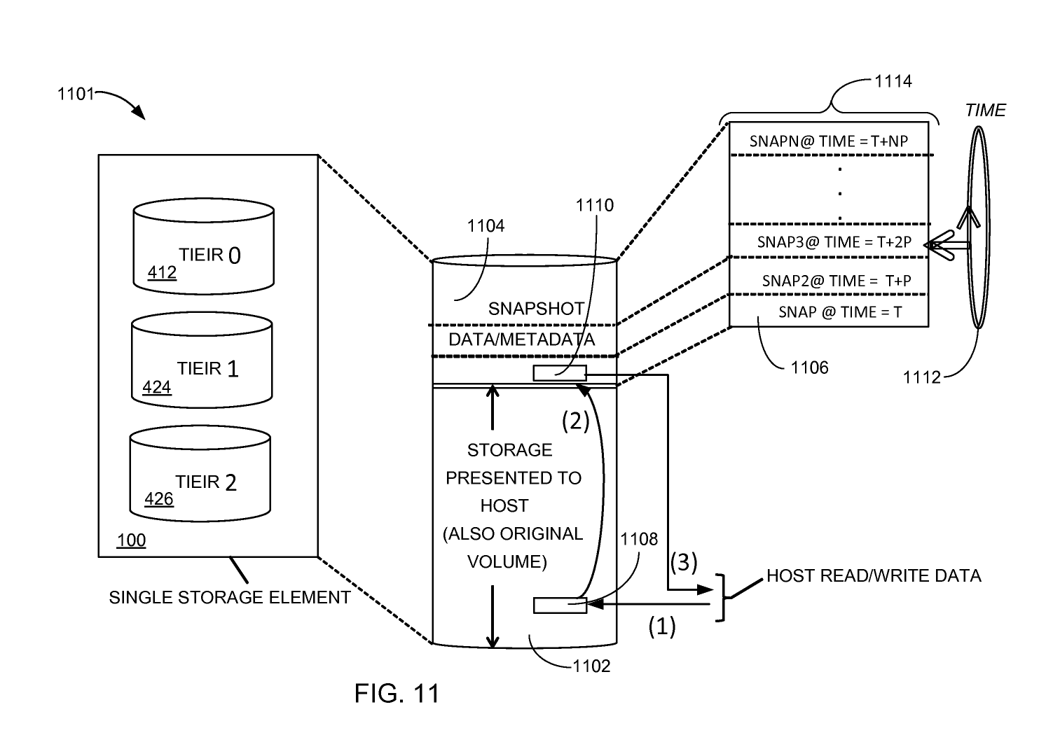

Referring now to FIG. 11, therein is shown a functional block diagram of the tiered data storage system 100 in a snapshot operation 1101. The functional block diagram of the tiered data storage system 100 depicts the tier zero 412, the tier one 424, and the tier two 426 shown within the tiered data storage system 100. While the total capacity of the storage devices of the tier zero 412, the tier one 424, and the tier two 426 are available to the tiered data storage system 100, only a portion of the total capacity is available to the host computer 302, of FIG. 3.

The storage processor 106 can perform several data migration and protection based schemes, for example creating whole volume snapshots for the purposes of creating subsequent point in time copies of data that can be easily restored in the tiered data storage system 100.

A host storage element 1102 can include the portion of the total capacity available to the host computer 302. A snapshot capacity 1104 is reserved for storing a snapshot data 1106, such as incremental volume changes to the data and the metadata for back-up and restore.

By way of an example, a host logical block 1108 may be written into the host storage element 1102. During the write operation, a snapshot block 1110 that reflects the content of the host logical block 1108 before the write can be saved into the snapshot capacity 1104. The snapshot operation 1101 is repeated at a predetermined interval of time 1112 and all of the snapshot data 1106 is stored in a snapshot pool area 1114.

The snapshot data 1106 from any particular one of the predetermined interval of time 112 can be used to regenerate the complete content of the host storage element 1102 as it was when the snapshot data 1106 was stored. It is understood that any number of the snapshot data 1106 can be saved in the snapshot pool area 1114. The snapshot pool area 1114 can operate as a circular queue in order to provide a fixed duration of recoverable states. Furthermore, the snapshot data 1106, snapshot pool 1114 and original volume 1102 in whole or in parts thereof may reside on anyone of the tiers 412, 424 and 426 depending on their relative activity levels and according to the tiering policies 108 of FIG. 1.

At each point the snapshot data 1106 is taken, the metadata records the changes made to the host storage element 1102 up to that point in time from the previous snapshot data 1106. In the event of a data recovery initiated by the host computer 302, the storage processor 106 can update the mapping register 110, of FIG. 1, to temporarily match the snapshot data 1106 of the predetermined interval of time 1112 that corresponds to the region of interest and presenting the host storage element 1102 as a read-only volume to the host computer 302 as an alternative host storage element (not shown) for the purposes of recovering or examining the original volume in an earlier state. Alternatively the storage processor 106 can permanently update the mapping register 110 to make the desired copy of the snapshot data 1106 the new current working copy of the host storage element 1102.

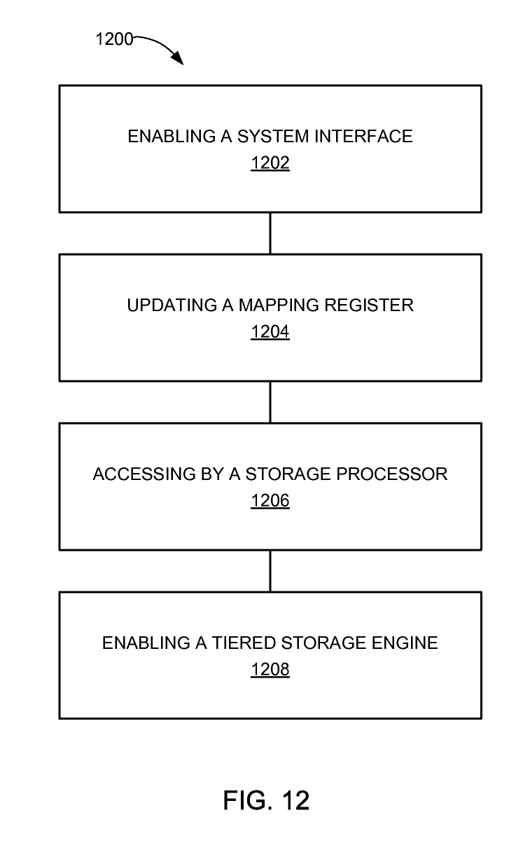

Referring now to FIG. 12, therein is shown a flow chart of a method 1200 of operation of the tiered data storage system 100 in a further embodiment of the present invention. The method 1200 includes: enabling a system interface for receiving host commands in a block 1202; updating a mapping register for monitoring transaction records of a logical block address for the host commands including translating a host virtual block address to a physical address for storage devices in a block 1204; accessing by a storage processor, the mapping register for comparing the transaction records with a tiering policies register in a block 1206; and enabling a tiered storage engine for transferring host data blocks by the system interface and concurrently transferring between a tier zero, a tier one, or a tier two if the storage processor determines the transaction records exceed the tiering policies register in a block 1208.

Thus, it has been discovered that the tiered data storage system and device or product of the present invention furnishes important and heretofore unknown and unavailable solutions, capabilities, and functional aspects for operating a tiered data storage system for optimizing the tiered data storage system performance without requiring the loading of a software driver specific to the tiered data storage system.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a data storage system comprising:
enabling a system interface for receiving host commands;
updating a mapping register for monitoring transaction records of a logical block address for the host commands including translating a host virtual block address to a physical address for storage devices;
accessing, by a storage processor, the mapping register for comparing the transaction records with a tiering policies register; and
enabling a tiered storage engine for transferring host data blocks by the system interface and concurrently transferring between a tier zero, a tier one, or a tier two if the storage processor determines the transaction records exceed the tiering policies register.

2. The method as claimed in claim 1 wherein transferring the host data blocks by the system interface includes:
accessing a storage port by the tiered storage engine; and
transferring storage data through the storage port including moving the storage data to the storage interface by the tiered storage engine.

3. The method as claimed in claim 1 further comprising accessing a local cache coupled to the tiered storage engine for transferring between storage data and the host data blocks.

4. The method as claimed in claim 1 further comprising activating a command handler by the system interface for executing the host commands.

5. The method as claimed in claim 1 further comprising capturing a snapshot data of an entire volume of a host storage element having a portion of the tier zero, the tier one, the tier two, or a combination thereof.

6. A method of operation of a data storage system comprising:
enabling a system interface for receiving host commands including configuring a block of storage ports for a tier zero, a tier one, and a tier two;
updating a mapping register for monitoring transaction records of a logical block address for the host commands including identifying a storage location in the tier zero, the tier one, or the tier two;
accessing, by a storage processor, the mapping register for comparing the transaction records with a tiering policies register; and
enabling a tiered storage engine for transferring host data blocks by the system interface and concurrently transferring between the tier zero, the tier one, or the tier two if the storage processor determines the transaction records exceed the tiering policies register.

7. The method as claimed in claim 6 wherein transferring the host data blocks by the system interface includes:
accessing a storage port by the tiered storage engine including selecting from a block of storage ports configured for the tier zero, the tier one, or the tier two; and
transferring storage data through the storage port including moving the storage data to the storage interface by the tiered storage engine.

8. The method as claimed in claim 6 further comprising accessing a local cache coupled to the tiered storage engine for transferring between storage data and the host data blocks including configuring a storage port for transferring the storage data.

9. The method as claimed in claim 6 further comprising activating a command handler by the system interface for executing the host commands including activating a logical block address match block for updating the transaction records for the host commands.

10. The method as claimed in claim 6 further comprising capturing a snapshot data of an entire volume of a host storage element having a portion of the tier zero, the tier one, the tier two, or a combination thereof including providing a snapshot pool area for storing the snapshot data by the storage processor.

11. A data storage system comprising:
a system interface for receiving host commands;
a mapping register addressed by the system interface for monitoring transaction records of a logical block address for the host commands includes a host virtual block address translated to a physical address of storage devices;
a storage processor coupled to the mapping register for comparing the transaction records with a tiering policies register; and
a tiered storage engine coupled to the storage processor for transferring host data blocks by the system interface and concurrently transferring between a tier zero, a tier one, or a tier two if the storage processor determines the transaction records exceed the tiering policies register.

12. The system as claimed in claim 11 wherein the host data blocks transferred by the system interface includes:
a storage port accessed by the tiered storage engine; and
a local cache coupled to the tiered storage engine contains storage data transferred through the storage port and moved to the storage interface by the tiered storage engine.

13. The system as claimed in claim 11 further comprising a local cache coupled to the tiered storage engine with storage data and the host data blocks stored.

14. The system as claimed in claim 11 further comprising a command handler activated by the system interface for executing the host commands.

15. The system as claimed in claim 11 further comprising a host storage element having a portion of the tier zero, the tier one, the tier two, or a combination thereof includes a snapshot capacity in the remaining portion accessed by the storage processor for regenerating an entire volume of the host storage element.

16. The system as claimed in claim 11 further comprising a block of storage ports configured for the tier zero, the tier one, the tier two, or a combination thereof.

17. The system as claimed in claim 16 wherein the host data blocks transferred by the system interface includes:
a storage port accessed by the tiered storage engine includes the storage port assigned to the tier zero, the tier one, or the tier two; and
a local cache coupled to the tiered storage engine contains storage data transferred through the storage port includes the storage data moved to the storage interface by the tiered storage engine.

18. The system as claimed in claim 16 further comprising a local cache coupled to the tiered storage engine with storage data and the host data blocks stored includes a storage port configured for transferring the storage data.

19. The system as claimed in claim 16 further comprising a command handler activated by the system interface for executing the host commands includes a logical block address match block activated for updating the transaction records for the host commands.

20. The system as claimed in claim 16 further comprising a host storage element having a portion of the tier zero, the tier one, the tier two, or a combination thereof includes a snapshot capacity in the remaining portion accessed by the storage processor for regenerating an entire volume of the host storage element including the storage processor updating the mapping register with a snapshot data from the snapshot capacity.
